(19) United States
(12) Patent Application Publication
(10) Pub. No.: US 2021/0268898 A1
(43) Pub. Date: Sep. 2, 2021

(54) HYDROSTATIC DRIVE SYSTEM FOR VEHICLES

(71) Applicant: DANA MOTION SYSTEMS ITALIA S.R.L., REGGIO EMILIA RE (IT)

(72) Inventors: DAVID GAMBUZZI, CASTELNUOVO RANGONE (IT); NICOLA FRANCESCO MUSCIAGNA, SAN GIOVANNI (IT); FABIO NATALI, MODENA (IT); NICOLA TESSARO, RIVA DEL GARDA (IT)

(73) Assignee: DANA MOTION SYSTEMS ITALIA S.R.L., REGGIO EMILIA (IT)

(21) Appl. No.: 17/261,201

(22) PCT Filed: Jul. 17, 2019
(86) PCT No.: PCT/IB2019/056098

§ 371 Date: Jan. 19, 2021

(30) Foreign Application Priority Data
Jul. 20, 2018 (IT) 102018000007368

(51) Int. Cl. B60K 17/10; B60K 17/16; F16H 48/08; F16H 57/037

(52) U.S. Cl. CPC B60K 17/105; B60K 17/16; F16H 2057/02052; F16H 57/037; F16H 48/08

(57) ABSTRACT

A hydrostatic drive system for vehicles may have a hydrostatic transmission unit with a hydraulic motor provided with a containment body and a drive shaft rotationally supported around a primary axis inside of the containment body. The system may also have an axle with a housing case for a differential device for the transmission of the drive torque to two half-axles and rotating around a secondary axis transverse to the primary axis. The differential device may also have a toothed conical drive ring gear in rotation about the secondary axis. The coupling member may be a conical pinion rigidly associated in rotation about the primary axis with the drive shaft and directly geared with the ring gear, the pinion being positioned along the terminal section of the drive shaft.

The subject of this invention is a hydrostatic drive system for vehicles.

Various types of vehicles, industrial and non-industrial, are known that employ drive systems comprising a hydrostatic transmission unit for rotational actuation of drive wheels through interposition of axles equipped with a differential device for distribution of the drive torque from a longitudinally extending drive axis to two driven transversally extending half-axles connected to respective wheels.

These hydrostatic transmission units essentially comprise a hydraulic circuit that uses the pressure of a working fluid output from a pump for actuation of a hydraulic motor equipped for output with a rotating drive shaft.

A connecting transmission shaft is interposed between the drive shaft of the hydraulic motor and the differential device of the axle.

In general, the drive shaft is provided with a terminal section comprising grooved profiles and the transmission shaft comprising, on a first end, a female seating provided with corresponding grooved profiles for the connection with the rotating shaft. Furthermore, an external safety sleeve is provided for binding together the rotating shaft and the transmission shaft.

The transmission shaft further provides for a conical pinion associated with the second end, opposite the first one, geared with the conical ring gear for rotational actuation of the differential device and the half-axles connected thereto.

The external case of the axle therefore provides for a tubular appendage passing through which the transmission shaft is inserted rotationally supported by related bearings, which is fitted with a flange for connection to the hydraulic motor case.

This known solution is not devoid of drawbacks, including the fact that the presence of the transmission shaft brings with it a notable increase in the axial extension of the system, with consequent installation problems, particularly in compact vehicles.

Furthermore, the need to provide for a mechanical connection between the transmission shaft and the rotating shaft from the hydraulic motor, as well as rotationally supporting the transmission shaft itself, increases the number of components necessary, with consequent manufacturing and assembly complications and an increase of production costs.

Moreover, the fact of having to provide for the housing of the transmission shaft complicates the realization of the axle case and increases related production costs.

A primary task of this invention is to eliminate the above drawbacks of the known art by devising a hydrostatic drive system for vehicles that makes it possible to considerably reduce longitudinal footprints, benefiting installation in vehicles with compact dimensions without involving particular design phase adaptations.

Within the scope of this technical task, another purpose of this invention is to reduce the number of components employed, simplifying the production cycle and reducing its costs. In particular, this invention makes it possible to reduce the number of rotational support bearings employed.

A further purpose of this invention is to simplify the structure of the component parts, particularly in relation to the axle case.

Another purpose of this invention is to present a simple structure, with relatively easy practical actuation, safely employed, and functionally efficacious, in addition to a relatively contained cost.

This task and these purposes are all achieved by this hydrostatic drive system for vehicles comprising a hydrostatic transmission unit comprising a hydraulic motor provided with a containment body and a drive shaft rotationally supported around a primary axis within said containment body and provided with a terminal section protruding to the outside of the body itself, and an axle comprising a case for housing of a differential device for the transmission of the drive torque to two half-axles supporting respective wheels and rotating along a secondary axis transverse to said primary axis, the differential device being provided with a toothed conical drive ring gear in rotation about said secondary axis operationally associated with said drive shaft for the transmission of the drive torque through a coupling member, characterized in that said member comprises a conical pinion rigidly associated in rotation about said primary axis with said drive shaft and directly in mesh with said ring gear, said pinion being positioned along the terminal section of said drive shaft.

Further characteristics and advantages of this invention will be more evident through the detailed description of some preferred, but not exclusive, embodiments of a hydrostatic drive system for vehicles, illustrated by way of non-limiting example in the accompanying drawings in which:

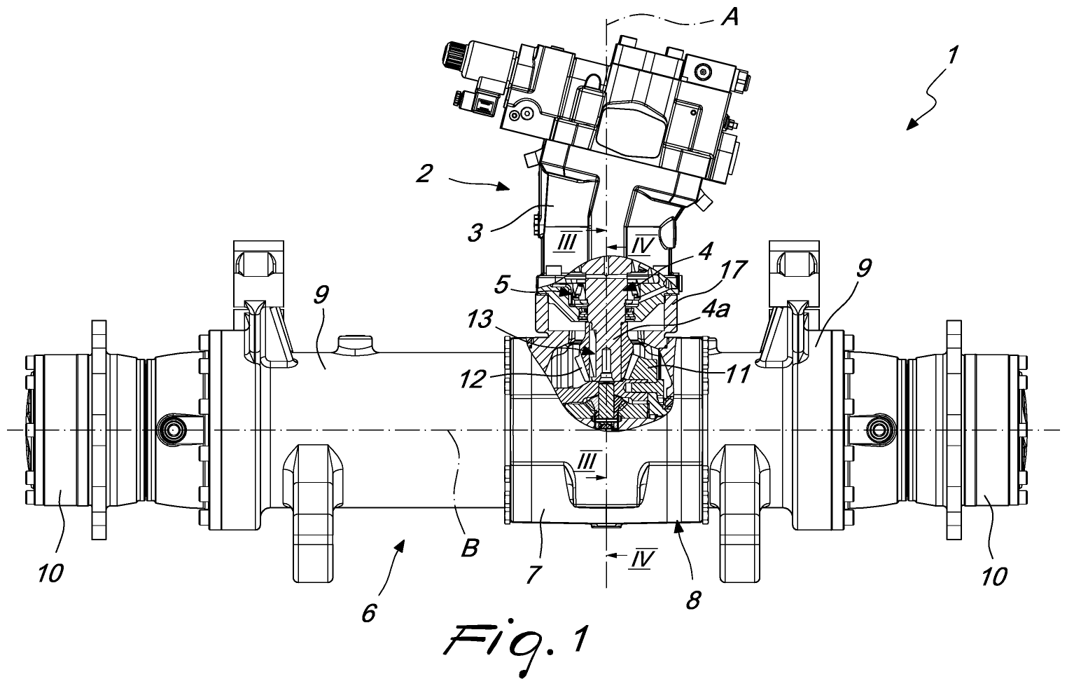

FIG. 1 is a schematic plan view from above of a hydrostatic drive system for vehicles, according to the invention, partially sectioned in correspondence to the coupling area between drive shaft and differential device;

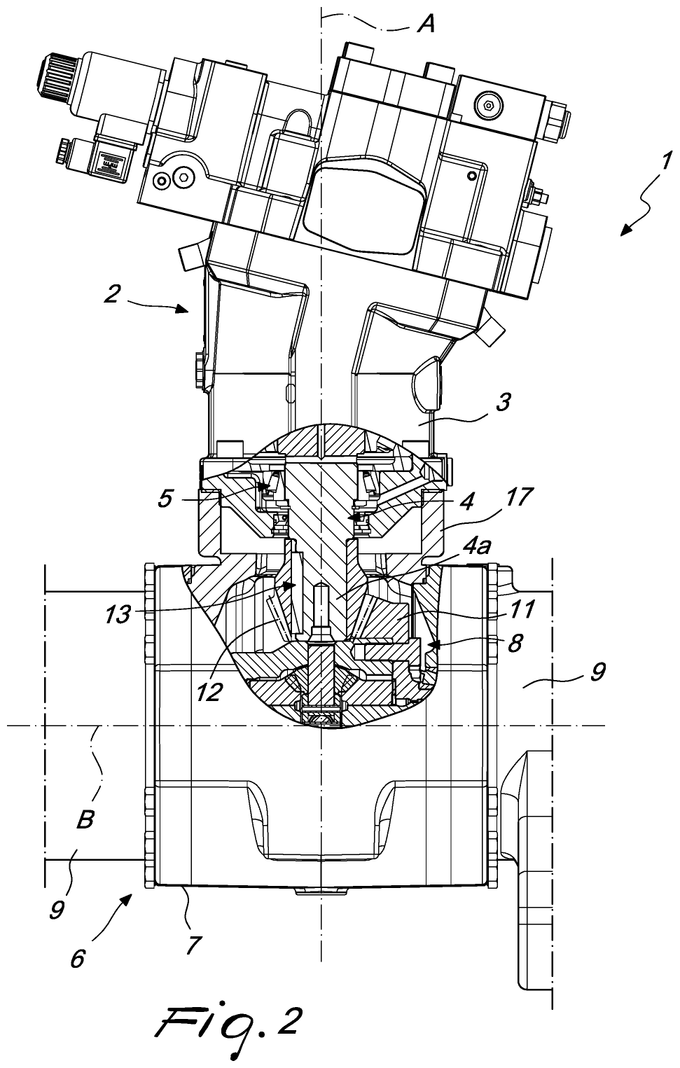

FIG. 2 is a schematic view on an enlarged scale of a portion from FIG. 1 comprising the coupling area between drive shaft and differential device;

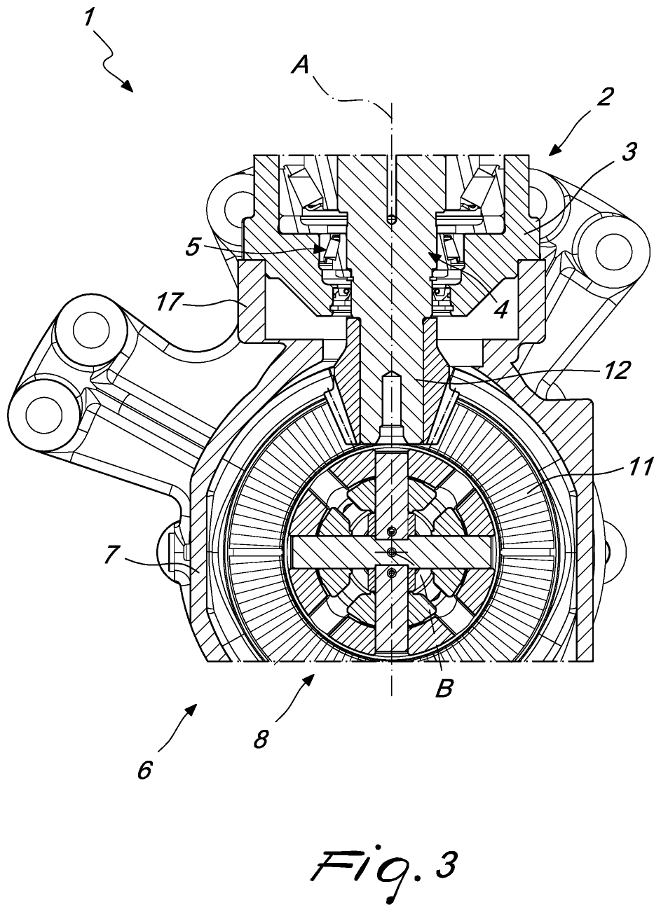

FIG. 3 is a schematic and partial view in sections according to the sectional plane III-III of FIG. 1;

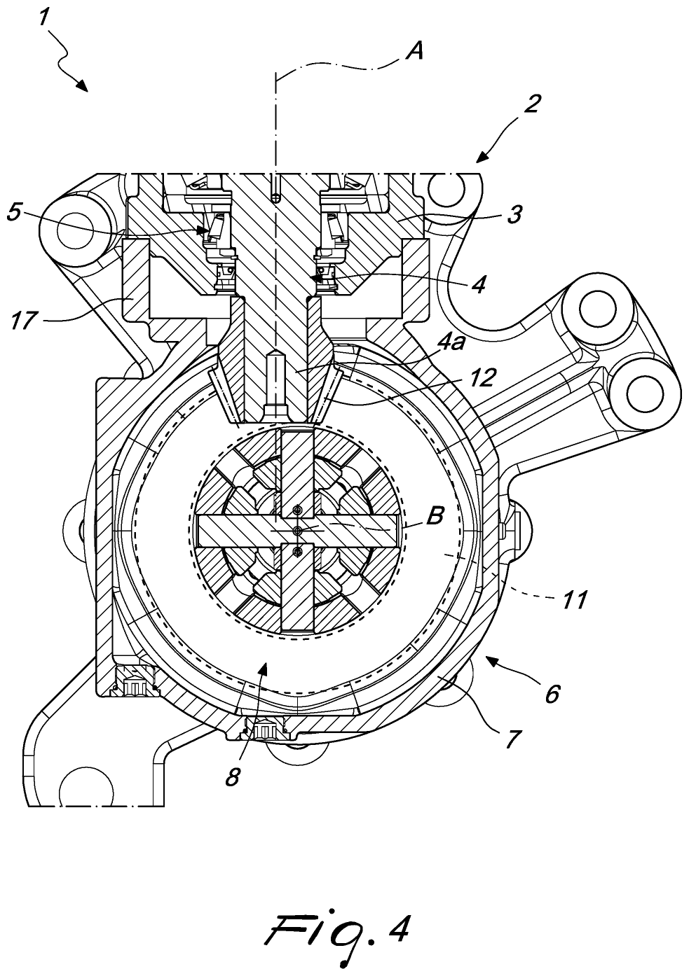

FIG. 4 is a schematic and partial view in sections according to the sectional plane IV-IV of FIG. 1 according to an alternative embodiment of the invention;

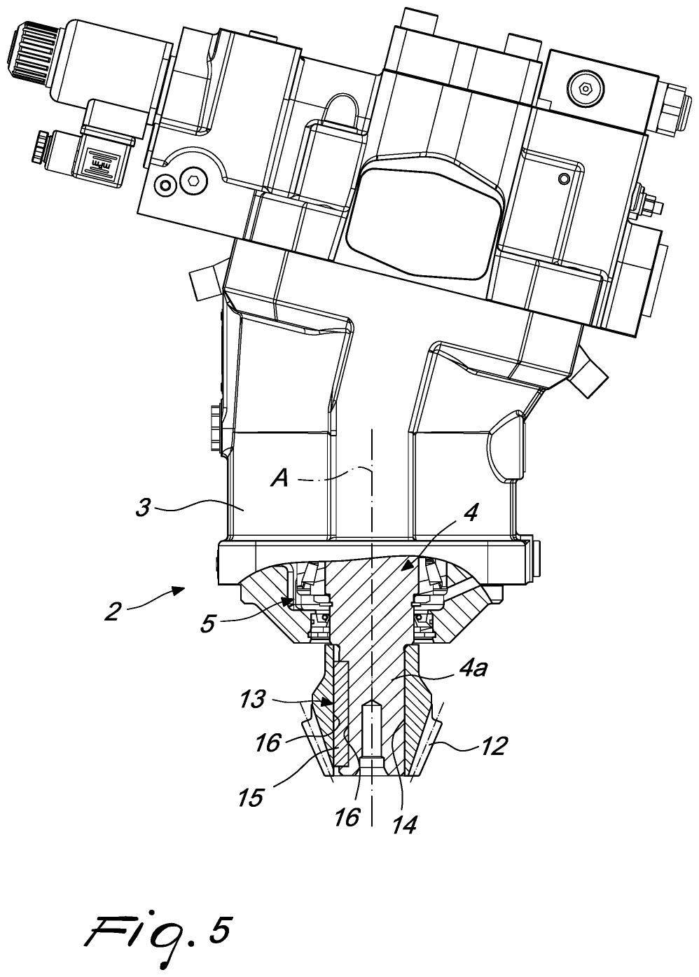

FIG. 5 is a schematic plan view from above of the hydraulic motor provided for in the system according to the invention, partially sectioned in correspondence to the drive shaft;

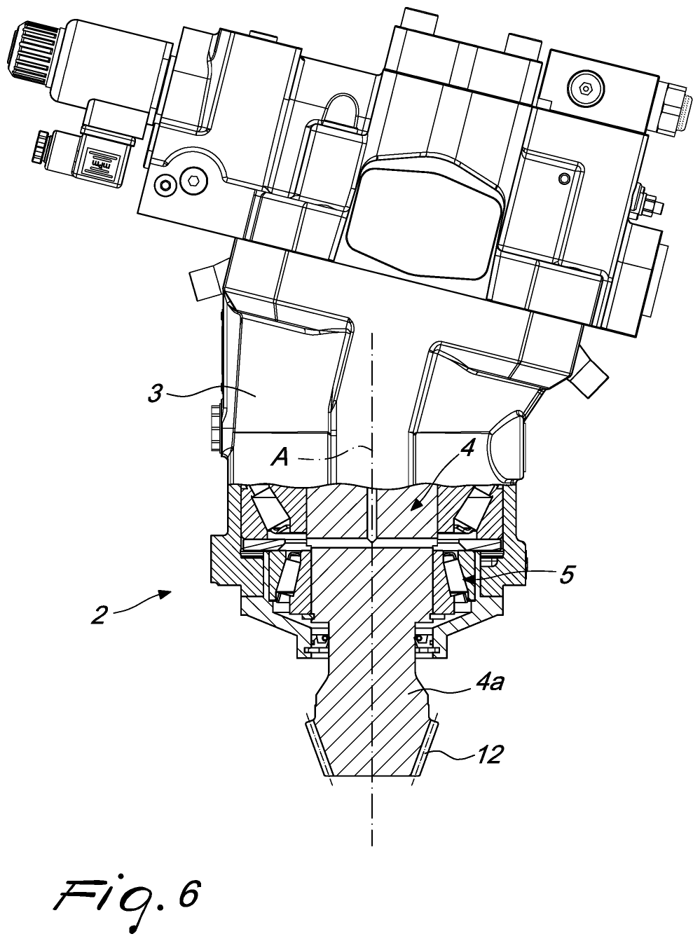

FIG. 6 is a schematic plan view from above of an alternative form for implementation of the motor from FIG. 5.

In particular reference to these figures, a hydrostatic drive system for vehicles is always indicated by 1.

The system 1 comprises a hydrostatic transmission unit, not represented or described in detail since it is of a known type. This unit comprises, essentially, a hydraulic system that uses pressure of a working fluid (hydraulic oil) output from a pump for actuation of a hydraulic motor 2.

The hydraulic motor 2 comprises a containment body 3 substantially box-shaped, inside of which are housed components for the transformation of the hydraulic energy of the working fluid into mechanical energy transmitted to an output drive shaft 4, wherein these components are not represented or described in detail since they are of a known type.

The drive shaft 4 is rotationally supported around a primary axis A, coincident with the longitudinal axis of the shaft itself, inside of containment body 3, and presents a terminal section 4a protruding to the outside of the body itself.

Within containment body 3, conventional bearing-type or similar rotational support members 5 are provided for drive shaft 4.

An inclined-body hydraulic motor 2 with axial pistons is represented in the figures. However, this does not rule out that system 1 may provide for the use of a different type of hydraulic motor 2, such as an axial piston motor with swashplate, a radial piston motor, a gear motor or an orbital motor. Furthermore, hydraulic motor 2 may have a fixed or a variable displacement.

System 1 further comprises an axle 6 having a housing case 7 for a differential device 8 for the transmission of the drive torque to two half-axles 9 bearing, at their respective ends, hubs 10 for support of corresponding wheels (not represented) and lying along a secondary axis B transverse to the primary axis A.

The differential device 8 comprises a toothed conical ring gear 11 that extends around the secondary axis B and that is operationally associated with the drive shaft 4 for the transmission of the drive torque through a coupling member 12.

According to the invention the coupling member is constituted by a conical pinion 12 rigidly associated in rotation about the primary axis A with the drive shaft 4 and directly in mesh with the ring 11, which is positioned along the terminal section 4a of the drive shaft 4.

In this way, interposing additional coupling members along the primary axis A between the drive shaft 4 and the ring gear 11 is avoided, so as to contain the required space of the system 1 in the axial direction.

Preferably, the pinion 12 is positioned in proximity to the free end of terminal section 4a of drive shaft 4.

In one preferred form of actuation, the pinion 12 is directly associated with the free end of the terminal section 4a of drive shaft 4.

The pinion 12 may be integrally formed with the drive shaft 4 in a single piece (FIG. 6), or it may be associated with the terminal section 4a of the shaft itself through rigid connection means 13.

In FIGS. 1-5, the pinion 12 features an axial hole 14 into which the terminal section 4a is inserted. Preferably, the rigid connection means 13 are of the obstacle and friction type and include a cotter 15 inserted into a corresponding hollow 16 defined between the wall of hole 14 and the external sleeve of the drive shaft 4.

However, this does not exclude that different embodiments of the rigid connection means may be provided for, which may provide, for example, the use of other systems using obstacle and/or friction or using dilation, or with grooved profiles.

In one possible embodiment (FIG. 3), the primary axis A and the secondary axis B are coplanar and incident to each other, preferably orthogonal. In this case the teeth of the ring gear 11 and of the pinion 12 may be straight, as represented, or helical.

In an alternative embodiment (FIG. 4) the primary axis A and the secondary axis B are skewed. In this case the teeth of the ring gear 11 and of the pinion 12 are hypoid.

The case 7 comprises a flange 17 for connection to the containment body 3, through which the terminal end 4a of drive shaft 4 passes.

The terminal section 4a is freely inserted through flange 17, or rotational support members are not interposed for the drive shaft 4 within case 7.

In this way, the structure of system 1, and in particular of case 7, is simplified with respect to known solutions, reducing both the number of, components employed and simplifying the realization and the assembly of system 1.

Furthermore, it should be noted that when using system 1 it can be installed either at the front or at the rear in a vehicle, based on the requirements of the specific application.

It has been found in practice how the afore-described invention achieves the proposed objects, and in particular it is emphasized that the system according to the invention features a restricted extension along the primary axis compared to known solutions, facilitating its use in compact vehicles.

Furthermore, the solution according to the invention features a simplified structure and a smaller number of components compared to known solutions.

Moreover, the system according to the invention may be realized with different types of hydraulic motors and axles, making it versatile as the characteristics of the specific application vary.

The invention as conceived is amenable to numerous modifications and variants, all of which are within the scope of the inventive concept.

In addition, all details may be replaced with other technically equivalent elements.

In practice, the materials used, as well as the shapes and contingent dimensions, may be any of those according to the requirements, without leaving the protective scope of the following claims.

1-10. (canceled)

11. A hydrostatic drive system for vehicles, comprising:
a hydrostatic transmission unit comprising a hydraulic motor equipped with a containment body and a drive shaft rotationally supported around a primary axis within said containment body and equipped with a terminal section protruding to the outside of the body itself; and
an axle comprising a housing case for a differential device for the transmission of drive torque to two half-axles bearing respective wheels and rotating around a secondary axis transverse to said primary axis;
the differential device being equipped with a toothed conical drive ring gear in rotation about said secondary axis operationally associated with said drive shaft for the transmission of the drive torque through a coupling member;
wherein said coupling member comprises a conical pinion rigidly associated in rotation about said primary axis with said drive shaft and directly in mesh with said ring gear, said pinion being positioned along the terminal section of said drive shaft.

12. The system according to claim 11, wherein said pinion is associated with said drive shaft in proximity to the free end of the terminal section.

13. The system according to claim 11, wherein said pinion and said drive shaft are integrally made in a single piece.

14. The system according to claim 11, wherein said pinion is associated with the terminal section of said drive shaft through a rigid connection device.

15. The system according to claim 11, wherein said pinion is directly associated with the terminal section of said drive shaft.

16. The system according to claim 11, wherein said primary and secondary axes are coplanar.

17. The system according to claim 16, wherein said primary and secondary axes are orthogonal to each other.

18. The system according to claim 16, wherein said ring gear and said pinion have respective straight or helical teeth.

19. The system according to claim 11, wherein said primary and secondary axes are skewed, and wherein said ring gear and said pinion having a hypoid toothing.

20. The system according to claim 11, wherein said case is provided with a flange for connection to said containment body through which the terminal section of said drive shaft passes.
